(19) United States
(12) Patent Application Publication
(10) Pub. No.: US 2002/0012023 A1
(43) Pub. Date: Jan. 31, 2002

(54) Ink-jet recording apparatus and cap for eject port

(76) Inventor: Kenji Shigeno, Kanagawa (JP)

Correspondence Address: FITZPATRICK CELLA HARPER & SCINTO, 30 ROCKEFELLER PLAZA, NEW YORK, NY, 10112, US

(21) Appl. No.: 09/907,674

(22) Filed: Jul. 19, 2001

(30) Foreign Application Priority Data
Jul. 21, 2000 (JP) 2000-221018

(51) Int. Cl. B41J 2/165

(52) U.S. Cl. 347/29

(57) ABSTRACT

The objective of the present invention is to provide an ink-jet recording apparatus which has a stable and widely applicable eject recovery means regardless of ink properties and recording head types for a compact and highly dense recording head equipped with a plurality of nozzles and nozzle rows. The ink-jet recording apparatus arranged as follows meets the above-mentioned requirements. A cap for capping a plurality of nozzle rows having a plurality of eject ports from which ink is ejected, communicating valves for communicating inner spaces of the cap to the atmosphere, a sucking means communicated to the cap for sucking ink from said nozzle rows, where; the cap is formed in one piece having a plurality of inner spaces corresponding to a plurality of eject ports, and a plurality of communicating valves are formed so as to communicate to the respective inner spaces and so as to control ejecting ink from nozzle rows by opening/closing operations by the communicating valves.

### BACKGROUND OF THE INVENTION

1. Field of the Invention

The present invention relates to an ink-jet recording apparatus for ejecting ink from a recording head, as a recording means, onto a recording medium, and also relates to a cap for capping eject ports during ink sucking or nonprinting operations.

2. Brief Description of the Related Art

Various kinds of recording methods, for example, wire-dot methods, thermal methods, thermal transfer methods or ink-jet methods have been proposed as mountable recording heads for recording apparatuses to record on printing media, as media to be recorded, such as paper, cloth, plastic sheets and OHP sheets etc. (Hereinafter also simply referred as “recording paper”).

Among these apparatuses, a printing apparatus employing the ink-jet printing method (hereinafter also referred as the ink-jet printing apparatus), where ink is ejected and deposited directly on the recording paper, is a non-impact printing method with low noise, capable of performing printings with high density and high quality. In general the ink-jet printing apparatus has a means for driving a carrier on which the print head is mounted, a feeding means for feeding the recording paper and a controlling means for controlling aforementioned means.

A piezo-electric element utilizing an electro-mechanical energy conversion module, a laser light irradiating method to generate thermal energy for ejecting ink droplets or an electro-thermal energy conversion element having a thermo-resistance element etc. have been known as energy generating elements to generate energy for ejecting ink from ink eject ports of the print head.

Among the above-mentioned print heads, the print head of the ink-jet printing method for ejecting ink as ink droplets by utilizing thermal energy is capable of printing with high resolution, since eject ports can be densely arranged. Above all, a print head utilizing the electro-thermal energy conversion element as the energy generating can be easily reduced in its size with densely packaged structure at low cost by utilizing IC related technologies and micro-fabricating technologies supported by advanced technologies and reliabilities attained in the recent semiconductor manufacturing field.

As mentioned above, the ink-jet printing method is the quite excellent printing method having a relatively simple arrangement, but still there are problems to be solved.

When the ink-jet recording apparatus has not been used for a long period or when one particular eject port among a plurality of eject ports rarely ejects ink compared with other eject ports, ink ejection is deteriorated in the ink-jet recording apparatus owing to ink thickening by evaporation of water in ink around eject ports or an ink chamber communicated to eject ports. Sometimes ejecting directions of ink are deviated by deposited ink droplets, water droplets or foreign particles on the eject port surface of the head where eject ports are arranged.

In order to prevent the above-mentioned problems, the conventional ink-jet recording apparatuses have the following means as devices for recovering ink ejection. For example, a pre-eject means for removing thickened ink and the like by ejecting ink into an ink accepting body before printing, an ink sucking means for sucking ink from eject ports and from common liquid chamber for removing deposited objects, a sucking means for removing bubbles generated in ink during exchanging ink tanks and a capping means for preventing water evaporation from ejects ports are employed in conventional ink-jet apparatuses.

An ink-jet recording apparatus capable of color printing equipped with the following arrangements has been developed: (a) a plurality of eject port groups for magenta, cyan and yellow inks etc. except black ink arranged in the same recording head, (b) ink tanks and ink supplying systems independently arranged in the respective eject port groups, (c) a common capping means or an ink ejection recovery means for these groups. In this type of the recording apparatus, usually color images are formed by two or three colors except black color. When ejecting volume of each color ink per dot are set the same volume as the black ink, dot diameters of the color ink recorded on the printing medium extend too large.

As measures against enlarged color dot diameters, a head having smaller eject port diameters or nozzles with smaller cross sectional areas for color inks are employed. Further in an ink ejection method where liquid droplets are ejected by generated heat from thermal energy generating elements etc., a head having smaller surfaced energy generating elements or larger distance between the energy generating element and the eject ports are employed.

However the ink eject recovery means for the head or head unit having a plurality of eject groups where different nozzle cross sectional areas or eject port sizes for respective eject port groups are arranged, has the following problem. Ejected ink volumes from respective eject port groups per one sucking recovery operation by the common cap are different from each other owing to different flow coefficients in respective eject port groups. In other words, larger ink volumes are sucked from eject port groups with larger flow coefficients and smaller ink volumes are sucked from other eject port groups with smaller flow coefficients.

When respective sucked ink volumes by the same sucking operation are different, sucking volumes should be set based on an eject port group with a minimum flow coefficient in order to remove bubbles generated during replacing the ink tank and thickened ink in ink supplying paths securely. Consequently, more ink volumes than required are sucked from other remaining eject port groups, as a result some volumes of ink are wasted.

In the Japanese laid open patent No. 7-52406, a recording head and an ink eject recovery device etc. for solving the above-mentioned problems are disclosed. According to the invention, since wasted ink volume during the recovery operation is reduced by setting summed up volumes of respective ink paths and a common liquid chamber according to respective flow coefficients of nozzles, the recovery for respective nozzle groups is executed by the same cap for sucking. Which securely reduces waste ink volumes.

However, in compliance with recent requirements such as more compact sized recording apparatuses, printing images with higher resolution or higher printing rates etc., more compact sized recording heads, smaller ink droplets from eject ports or higher ejecting velocity have been required. Consequently, stored ink volumes in the common liquid chambers are diversified according to the above-mentioned requirements. Further since various types of inks such as ink with high coloring and high light stability and ink with more stable fixing etc. have been increasing, inkjet recording apparatuses equipped with recording heads to meet diversified flow coefficients and ink types are developed. For example, an ink-jet recording apparatus primarily for recording images with high quality and an ink-jet recording apparatus primarily for higher printing rates etc. have been proposed.

An ink eject recovery device not only attaining stable ink eject recovering functions applicable to recent ink-jet recording apparatuses mentioned above, but also applicable to a recording head employable any type of ink without wasting ink during recovery operation, is required.

### SUMMARY OF THE INVENTION

The present invention is carried out in view of the above-mentioned technical problems for providing an ink-jet recording apparatus equipped with a stable and widely applicable ink eject recovery means for a compact sized recording head having a plurality of densely arranged nozzles and nozzle rows regardless of ink properties or types of recording heads.

The ink-jet recording apparatus according to the present invention is arranged as follows.

(1) An ink-jet recording apparatus comprising: a cap for capping a plurality of eject ports for ejecting ink, a communicating valve for communicating the cap to an atmosphere, a sucking means communicated to the cap for sucking ink from eject ports, where; the cap has a plurality of inner spaces in an integrated form respectively corresponding to eject ports, and a plurality of communicating valves are provided so as to communicate to inner spaces respectively.

(2) The ink-jet recording apparatus according to (1) comprising: a recording head having a plurality of eject port rows for ejecting ink, a carriage for mounting the recording head to move reciprocatingly, a capping means for making the cap in contact to or separated from an eject port surface of the recording head, a switching means for opening or shutting communicating valves, where; the cap is formed in one piece having a plurality of inner spaces respectively corresponding to the eject port rows of the recording head.

(3) The ink-jet recording apparatus according to (2) where; a partition dividing the cap into a plurality of inner spaces is formed as one wall and a thickness of the partition is set equal to or less than a thickness of other surrounding rib of the cap, and contact surfaces of the cap surrounding inner spaces to be in contact with the recording head are arranged on a same plane.

(4) The ink-jet recording apparatus according to (2) where the capping means comprises; a cap holder to fix the cap, one or more compression springs for applying pressure to the bottom plane of the cap holder, a cap base for supporting the opposite ends of compression springs and for supporting the cap holder so that the cap holder generates a capping pressure against the eject surface of the recording head, and a cap lever for bringing the cap base closely to the recording head or for keeping the cap base away from the recording head.

(5) The ink-jet recording apparatus according to (4) where: one compression spring of the capping means is arranged at the center of gravity of a rib plane formed by a contacting plane contacting with the eject port surface of the recording head, or arranged below the rib plane along a perpendicular line to the rib plane passing through the center of gravity of the rib plane; or a plurality of compression springs of the capping means are arranged on or below the rib plane of the cap holder so as to surround a perpendicular line to the rib plane passing through the center of gravity of the rib plane.

(6) The ink-jet recording apparatus according to (1) where; the sucking means is formed as tube pumps for generating a negative pressure around eject ports by pressing pressurizing rollers against tubes connected to eject ports of the recording head so as to eject ink from eject ports, and pressurizing rollers are moved in a direction for relieving the applied pressure against tubes when pressurizing rollers are driven in a reverse direction to the pressure applying direction.

(7) The ink-jet recording apparatus according to (2), where; the recording head is equipped with electro-thermal energy conversion elements to generate thermal energy utilizing for ejecting ink.

(8) The ink-jet recording apparatus according to (7), where; ink is ejected from eject ports by utilizing film boiling in the ink caused by thermal energy generated from electro-thermal elements.

(9) A cap for use in an ink-jet recording apparatus for capping a plurality of eject ports for ejecting ink, where: the cap has a plurality of inner spaces in an integrated form respectively corresponding to eject ports.

(10) The cap according to (9), where: a partition dividing the cap into a plurality of inner spaces formed in one wall and a thickness of the partition is set equal to or less than a thickness of other surrounding rib of the cap; and contact surfaces of the cap surrounding inner spaces to be in contact with the recording head are arranged on a same plane.

### BRIEF DESCRIPTION OF DRAWINGS

FIG. 1 is a perspective view illustrating the inner structure of an ink-jet recording apparatus according to the present invention.

FIG. 2 is a perspective view illustrating an ink eject recovery device equipped in the ink-jet recording apparatus shown in FIG. 1.

FIG. 3 is an exploded perspective view illustrating the inner structure of the ink eject recovery device shown in FIG. 2.

FIG. 4 is a perspective view illustrating a capping means equipped in the ink-jet recording apparatus shown in FIG. 1.

FIG. 5 is a plan view illustrating an arrangement of the capping means shown in FIG. 4.

FIG. 6 is a partial perspective diagram illustrating a relation between the cap shown in FIG. 4 and an eject port area of a recording head linked to the cap.

FIG. 7 is a cross sectional side view illustrating the structure of the cap shown in FIG. 5.

FIG. 8 is a partial perspective diagram illustrating a geometrical relation between the cap holder and the cap.

FIG. 9 is a perspective view illustrating a status where both communicating valves to the atmosphere are closed (cap closed status) according to the present invention.

FIG. 10 is a perspective view illustrating a status where both communicating valves to the atmosphere are open (dummy sucking status) according to the present invention.

FIG. 11 is a perspective view illustrating a status where the communicating valve to the atmosphere for color ink is open (black ink is in a sucking status) according to the present invention.

FIG. 12 is a perspective view illustrating a status where the communicating valve to the atmosphere for black ink is open (color ink is in a sucking status) according to the present invention.

FIG. 13A is a plan view illustrating a relation between one compression spring and the cap holder and FIG. 13B is a plan view illustrating a relation between several compression springs and the cap holder according to the present invention.

FIG. 14 is a side view illustrating a detailed structure of a sucking means equipped in the ink eject recovery device shown in FIG. 3.

FIG. 15 is a partial perspective diagram illustrating a shape of a cap and an eject port area of a recording head linking to the cap.

FIG. 16 is a flow chart showing a series of eject recovery procedures according to the present invention.

FIG. 17 is a partial perspective view illustrating a structure of ink ejecting portion of the recording head equipped in the ink-jet recording apparatus shown in FIG. 1.

### DETAILED DESCRIPTION OF THE PREFERRED EMBODIMENTS

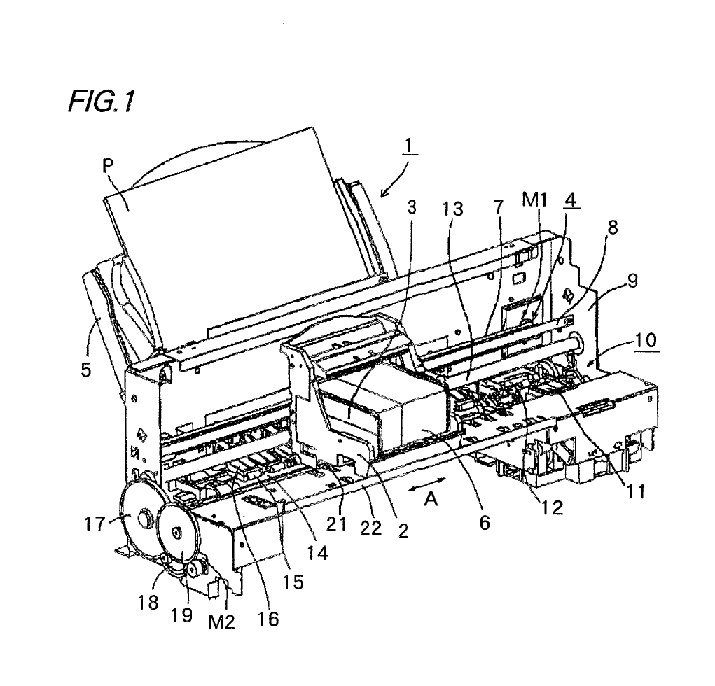

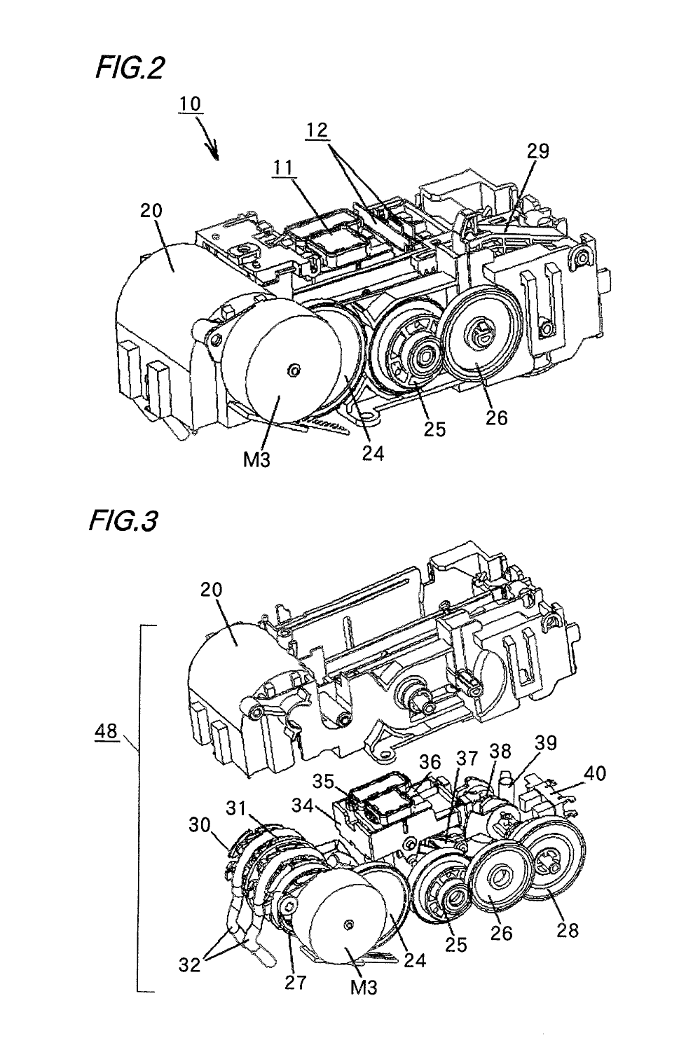

Hereinafter referring to drawings, embodiments according to the present invention are explained. Throughout drawings the same signs represent the same members or portions. FIG. 1 is the perspective view illustrating the inner structure of the ink-jet recording apparatus according to the present invention. FIG. 2 is the perspective view illustrating the ink eject recovery device equipped in the ink-jet recording apparatus shown in FIG. 1. FIG. 3 is the exploded perspective view illustrating the inner structure of the ink eject recovery device shown in FIG. 2.

A numeric character “1” is an ink-jet recording apparatus equipped with a carriage motor M1 as a driving source, a carriage 2 on which a recording head (recording means) 3 is mounted, a transmission mechanism 4 which moves the carriage 2 reciprocatingly in directions depicted by an allow A by the carriage motor M1, a paper supplying mechanism (a paper feeding mechanism) 5 which feeds (sends) a recording paper P, as a medium to be recorded, and an ink eject recovery device 10 for recovering ejection from the recording head 3 by keeping the eject port surface clean.

In the ink-jet recording apparatus 1, the recording paper P is sent by the paper supplying mechanism 5 and required recording is executed on the recording paper P by the recording head 3. An ink cartridge 6 is demountably mounted on the carriage 2 on which recording head 3 is mounted.

Ink accommodated in the above-mentioned ink cartridge 6 is supplied to the recording head 3. In this case, the carriage 2 and recording head 3 are properly contacted via respective contact surfaces so as to maintain a required electrical connection between them. The above-mentioned recording head 3 is a recording head for the ink-jet recording apparatus where ink is selectively ejected from a plurality of eject ports by applied energy to the recording head 3 in accordance with recording signals.

The recording head 3 is a recording means for the ink-jet recording apparatus to eject ink by utilizing thermal energy generated from electro-thermal energy conversion elements arranged in the recording head. In other words the recording head 3 ejects ink from eject ports for recording by utilizing pressure fluctuations caused by growing/shrinking bubbles from film boiling brought by applied thermal energy from the above-mentioned electro-thermal energy conversion elements.

The electro-thermal energy conversion elements arranged corresponding to respective eject ports are elements for generating thermal energy by applied voltages to the elements in accordance with recording signals for ejecting ink from respective eject ports.

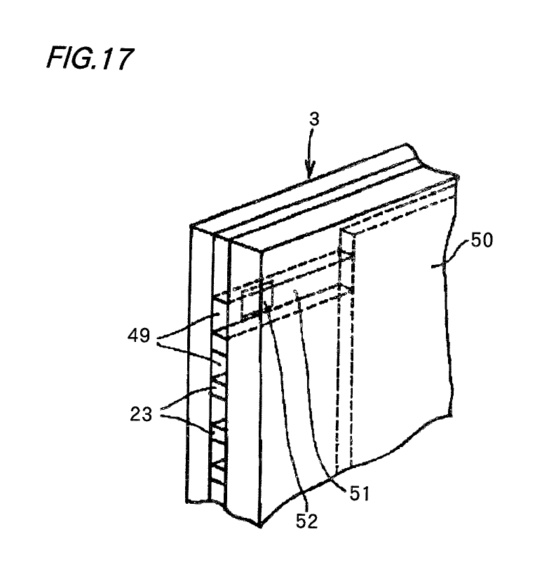

FIG. 17 is the partial perspective view illustrating the structure of ink ejecting portion (one eject port row) of the recording head (recording means) 3. As shown in FIG. 17, a plurality of eject ports 49 are formed with a predetermined pitch on eject port surfaces 23 facing the recording paper P with a predetermined spacing (for example, 0.3 to 2.0 mm). Electro-thermal energy conversion elements (exothermic resistance etc.) 52 to generate energy for ejecting ink are respectively arranged along walls of respective liquid paths 51, via which respective eject ports 49 are communicated to a common liquid chamber 50.

The recording head 3 is guided and supported in a status where the eject ports 49 are arranged in a row crossing a main scanning direction (in this embodiment the moving direction A of the carriage 2 on which the recording head is mounted).

In the above-mentioned way, the recording head 3 is arranged to eject ink droplets from eject ports 49 by utilizing the generated pressure by the film boiling in liquid paths 51 caused by applied voltages to respective electro-thermal energy conversion elements 52 in accordance with image signals or ejection signals.

The carriage 2, shown in FIG. 1, is linked to a driving belt 7 of the driving mechanism 4, to which a driving force from the carriage motor M1 is transmitted. The carriage 2 is arranged to slide along a guide shaft 13 in the direction of the arrow A, namely to move reciprocatingly in accordance with forward/backward rotations of the carriage motor M1.

A numeric character “8” is a scale to indicate a position of the carriage 2 along the direction of the arrow A. In this embodiment the scale 8 is formed out of transparent PET film on which black bars are printed with a predetermined pitch. One end of the scale 8 is fixed to a chassis 9 and the other end of the scale 8 is supported by a flat spring (not shown in drawings).

On the ink-jet recording apparatus 1 shown in FIG. 1, a platen (not shown) is arranged so as to face against the eject port surface where eject ports (not shown) are formed. Along the full width of the recording paper P (as the recording medium) fed to the platen, recordings are executed by ejecting ink in accordance with recording signals to the recording head 3 together with reciprocating movements of the recording head 3 mounted on the carriage 2 driven by the driving force from the carriage motor M1.

A numeric character “14” is a feeding roller for feeding the recording paper driven by a feeding motor M2. A numeric character “15” is pinch rollers for pressing the recording paper against the feeding roller 14 by a spring (not shown). A numeric character “16” is pinch roller holders for rotatably supporting the pinch rollers 15.

A numeric character “17” is a feeding roller gear for driving the feeding roller 14 via an intermediate gear 18 to which rotations of the feeding motor M2 is transmitted.

A numeric character “19” is an ejecting roller gear fixed to an ejecting roller 20 (not shown in FIG. 1) for ejecting the recorded paper where an image is formed by the recording head 3. The ejecting roller 20 (see FIG. 2 and FIG. 3) is driven by revolutions of the feeding motor M2 transmitted via intermediate roller 18 to the ejecting roller gear 19. A numeric character “21” is a spurring roller for pressing the recorded paper against the ejecting roller 20 via a spring (not shown). A numeric character “22” is a spurring roller holder for rotatably supporting the supporting roller 21.

The ink eject recovery device 10 for recovering to a normal ejection status in the recording head 3 is arranged at a desired position (for example a position facing against a home position of the recording head 3). But it should be arranged outside the reciprocating moving area for recording (outside recording area) of the carriage 2 on which the recording head 3 is mounted.

A capping means 11 for capping over the eject surface of the recording head 3 and a wiping means 12 for cleaning the eject port surface of the recording head 3 are equipped in the ink eject recovery device 10. Together with the capping movement over the eject surface by the capping means 11, ink is forcibly ejected by a sucking means (such as sucking pump and the like, not shown in drawings) equipped in the ink eject recovery device. Thus the ink eject recovery procedure for removing thickened ink and bubbles etc. in liquid paths is executed.

Capping over the eject port surface of the recording head 3 during non-printing operations can prevent ink from drying as well as can protect the recording head. The wiping means 12 is arranged in the vicinity of the capping means 11 so as to wipe up stuck ink on the eject surface of the recording head 3.

The capping means 11 and wiping means 12 can keep the recording head 3 in the normal status.

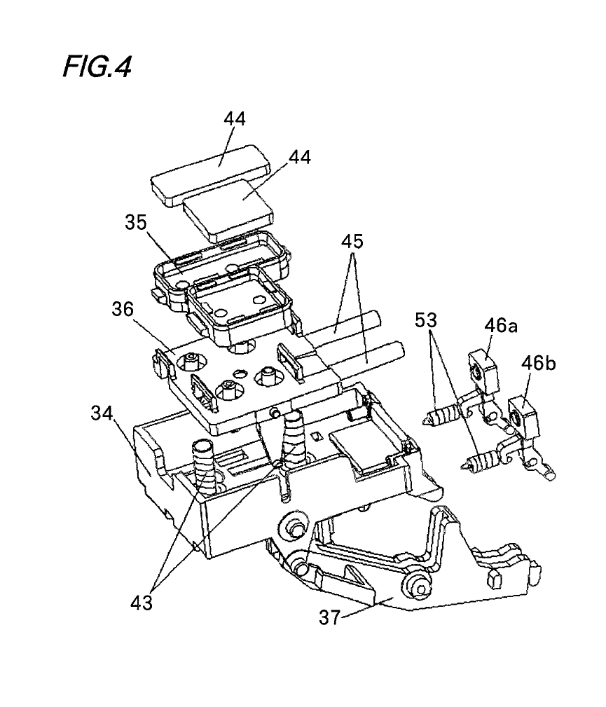

FIG. 4 is the exploded perspective view illustrating the internal arrangement of the capping means 11 shown in FIG. 1 and FIG. 2. Hereinafter the arrangement of the ink eject recovery device 10 which includes the ink eject recovery means, a characteristic feature of the present invention, is explained by referring FIGS. 2, 3 and 4. The ink eject recovery device 10 comprises a sucking means 48 (see FIG. 3), the capping means 11 and the wiping means 12.

FIG. 14 is the side view illustrating a detailed arrangement of the sucking means 48. The sucking means 48 in FIG. 14 comprises as follows. Two sucking tubes 32 are guided along an inner circular surface of a base cover 20 of the sucking means. Two pressurizing rollers 33 having respective axes are arranged to each sucking tube. The pressurizing rollers 33 are pressed against the sucking tubes 32 by springs (not shown in drawings) for generating negative pressure in sucking tubes 32. Pressurizing rollers 33 are placed in oval openings of pressurizing roller holders 31 so that the pressurizing rollers 33 are in pressing positions against sucking tubes 32 during sucking operations and in idle positions during non-sucking operations.

In this embodiment, since the base cover 20 has semicircular surface, one of the two pressurizing rollers 33 always presses against the sucking tubes 32 while the other pressurizing roller 33 is in the idle position by arranging two pressurizing rollers 33 in the opposite side of a circle formed by the base plate cover. Thus, continuous sucking operations are attained when pressurizing rollers 33 are revolved continuously with keeping the negative pressure in the sucking tubes 32.

When the base cover has a full circular surface, even one pressurizing roller may attain the same result as mentioned above. Even when the base cover has the semicircular surface, the continuous sucking operations are realized by employing two or more pressurizing rollers. The pressurizing roller holders 31 are fitted to a pressurizing roller holder guide 30 so as to revolve in a radial direction of the base cover 20 for attaining a cyclic pressurizing/idle positioning of pressurizing rollers 33 against sucking tubes 32.

The pressurizing roller holder guide 30 has axes on its both sides and rotatably fitted to the circular center formed by the inner surface of the base cover 20 where sucking tubes 32 are arranged via their axes. A driving power from a PG motor (recovery motor) M3 shown in FIG. 2 and FIG. 3 is transmitted to and revolves the pressurizing roller holder guide 30 via PG gear 24 and a pump gear 27 arranged in the sucking means 48 so as to execute sucking recovery operations.

The revolving drive from the PG motor M3 is directly linked to the sucking means 48 so as to revolve in a circular direction for the sucking operation (hereinafter referred as “forward revolution”) and to revolve in a reversed direction for moving the pressurizing rollers 33 from a pressurizing status to a pressure free status against sucking tubes 32 (hereinafter referred as “backward revolution”). In this embodiment, the sucking means 48 is driven by one driving source in the recovery device, but other different driving sources are also applicable to the sucking means 48.

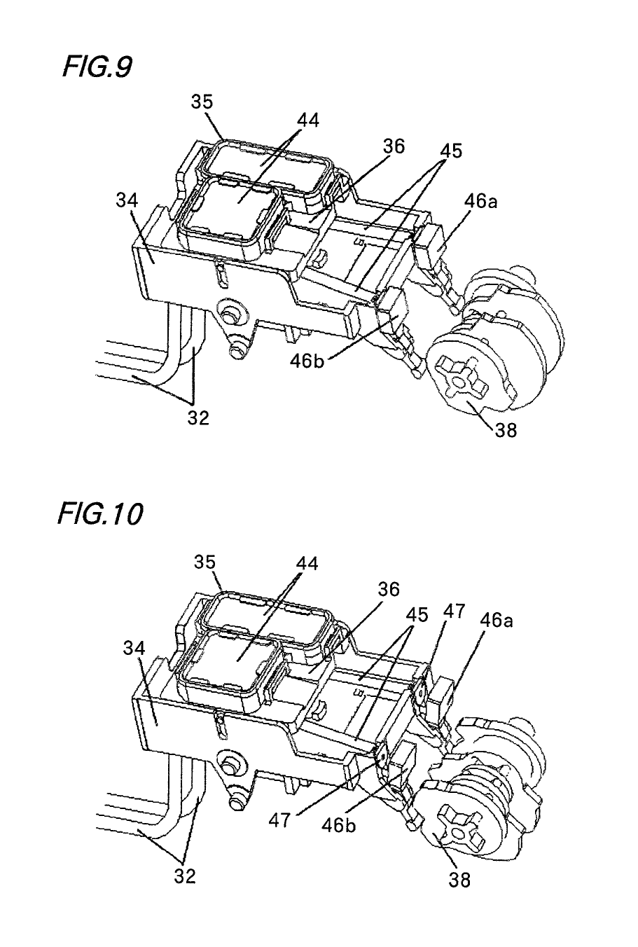

As shown in FIG. 4, the capping means 11 comprises as follows: a cap 35 directly connected to the eject surface of the recording head 3; cap absorbers 44 for absorbing ejected ink from eject port surface of the recording head 3 effectively; a cap holder 36 for supporting the cap and for pressing the cap 35 against eject port surface of the recording head 3 via compression springs 43; a cap base 34 for supporting compression springs 43 so as to apply a pressure against the cap holder 36 and for supporting cap holder 36 so as to flexibly slide upward/downward; a cap lever 37 functioning as an arm to press or remove the cap 35 against or from the eject port surface of the recording head 3; communicating tubes 45 to the atmosphere for communicating the cap base 34 and communicating holes 47 (shown in FIG. 9 to FIG. 12) to the atmosphere formed in the cap base 34 and communicating valves 46a (for black ink) and 46b (for color inks) for opening or closing communicating holes 47 so as to make the cap 35 open or close.

In the capping means 11, the sucking tubes 32 of the sucking means 48 are linked to joints formed on the cap holder 36 so as to suck ink from the recording head 3 by applying the negative pressure caused by the sucking movements of the sucking means 48 to the cap 35 as far as the capping means is pressed against to ink eject port surface of the recording head 3.

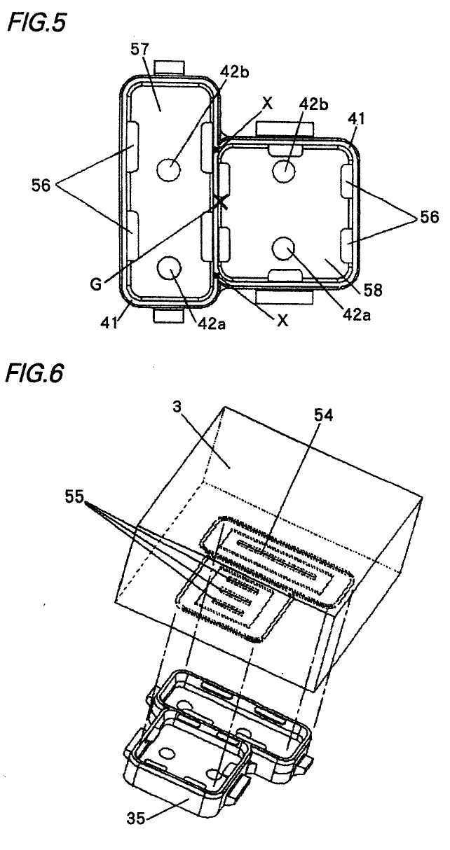

FIG. 5 is the plan view of the cap 35 shown in FIG. 4. FIG. 6 is the partial perspective view showing the contacting area between the cap 35 in FIG. 4 and the eject port surface. As shown in FIG. 5 and FIG. 6, a plurality of nozzle rows, a black ink nozzle row 54 and color ink nozzle rows 55, are arranged in the recording head 3. Consequently, the cap 35 is divided into two areas, one for a black ink cap area 57 and the other for a color ink cap area 58. Two cap absorbers 44 fitted in the cap by cap absorber pressing ribs 56 are arranged in respective cap areas 57 and 58. Two communicating tubes to the atmosphere and communicating valves 46a and 46b to the atmosphere supported by the cap base 34 via axes with applied pressure from valve springs 53 are also arranged in the capping means. Characters “X” in FIG. 5 designate crossing points of black ink cap rib and color ink cap rib.

Openings 42a (sucking side) for guiding the sucking tubes 32 to the cap holder 36 and openings 42b (atmosphere side) for guiding communicating tubes 45 to the cap holder 36 are formed on respective ink cap areas 57 and 58 so that each sucking tube and communicating tube is engaged to joints formed on the cap holder 36.

Upward/downward movements of the capping means 11 for pressing to the recording head and open/close movements of valves 46a and 46b are executed by the driving force from the PG motor M3. The driving force from the PG motor M3 is successively transmitted to a PG gear 25, to a PG gear 26 and to a one-way clutch gear 28 which is mated to a cum 38 (see FIG. 3). The one way clutch gear 28 transmits the driving force to the cum 38 when the PG motor M3 revolves in one direction and the one way clutch gear 28 disconnects the driving force to the cum 38 when the PG motor M3 revolves in the reverse direction.

The above-mentioned cum 38 controls not only movements of the above-mentioned capping operations but also drives the wiping means 12 and controls upward/downward movements of a CR lock lever 29 (see FIG. 2) for positioning the recording head 3 and the capping means during ink eject recovery operations of the recording head 3. A revolving position of the cum 38 is determined by a cum position detecting sensor 40 and a flag for shielding the cum position detecting sensor equipped to the cum 38 so as to control respective means.

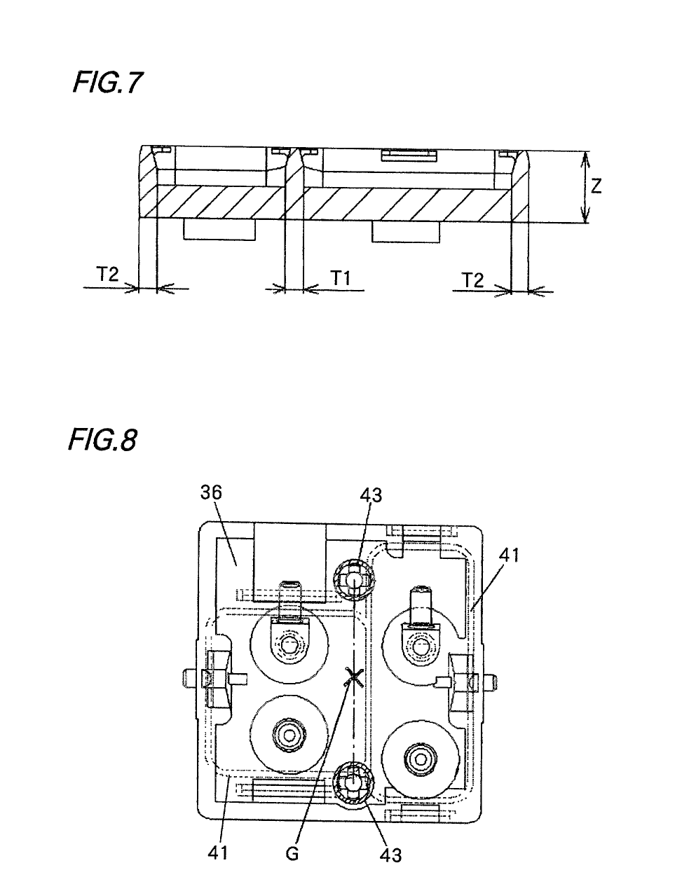

The present invention relates to ink-jet recording apparatus equipped with the recording means having a plurality of eject port rows for ejecting ink, the carriage on which the recording means is mounted moving reciprocatingly and the ink eject recovery means for recovering or keeping the normal ink ejecting statues in eject ports. In addition, the present invention includes features that are explained hereinafter. Characteristic features of sucking recovery modes in the ink eject recovery device of the ink-jet recording apparatus and of the capping means are explained by referring FIG. 7 to FIG. 16.

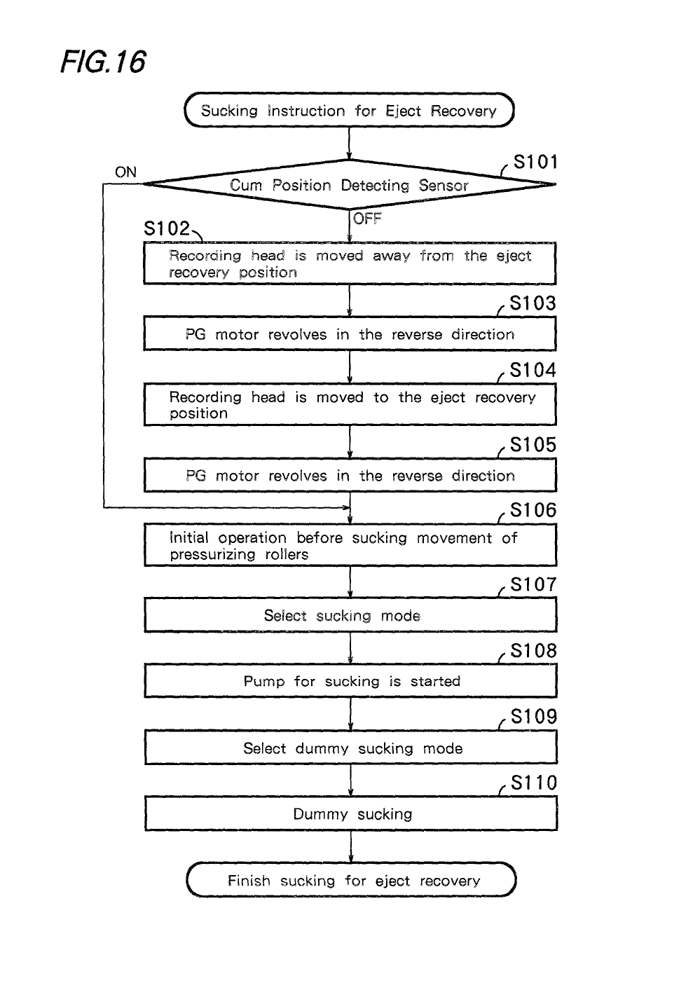

FIG. 16 is the flow chart showing the sucking operations for eject recovery in one of the embodiments. The sucking operations for eject recovery by the ink eject recovery device against the recording head 3 are executed according to a sequence shown in FIG. 16. Hereinafter sucking recovery modes are explained in detail according to the sequence in FIG. 16. Sucking operations for eject recovery are carried out according to instructions from a CPU (not shown in drawings) based on a program stored in a ROM (not shown in drawings).

When a sucking instruction for eject recovery is issued, a position of the cum 38, a member of the eject recovery device, is detected by the cum position detecting sensor 40 and positions of the capping means 11 and the wiping means 12 etc. are confirmed (step S101). When the recording head 3 is not at the sucking position for eject recovery, after confirming that the recording head 3, the capping means 11 and wiping means 12, members of the eject recovery unit, are not in a status where they do not interfere each other by the cum position detecting sensor 40, the recording head 3 is moved to the sucking position for eject recovery by the transmission mechanism 4 shown in FIG. 1 (step S104). When the recording head 3 is in the position of the eject recovery operation, the recording head 3 is moved away from the position (step S102) and the PG motor M3 is revolved in the reverse direction (R direction) (step S103) until the wiping operation is finished. Then the recording head 3 is moved in a position of the sucking for eject recovery (step S104).

The capping means 11 is pressed against the eject port surface of the recording head 3 by revolving the cum 38 revolved by the PG motor M3 so as to execute the sucking operation for eject recovery (step S105). In this step, since the revolving direction of the PG motor M3 is in the reverse direction (R direction in FIG. 14), the pressurizing rollers 33 of the sucking means 48 are positioned away from sucking tubes 32 where the inside of the cap 35 communicates to the atmosphere so that ink remaining in sucking tubes 32 does not flow into the inside of the cap 35 and physical damages against eject ports of the recording head 3 due to the positive pressure are prevented. (The PG motor M3 is revolved in the reverse direction until a PG sensor is activated.) After pressing the cap 35 against the eject port surface of the recording head 3, the PG motor M3 in the sucking means 48 is revolved in the forward direction (L direction in FIG. 14) so as to press the pressurizing rollers 33 arranged in the sucking means 48 against the sucking tubes 32 as a preparation for the sucking recover operation (step S106, an initial operation before the sucking movement of the pressurizing rollers).

In this step since the capping means is pressed against the eject port surface of the recording head 3, communicating valves 46a and 46b are kept in the open status (see FIG. 10) by revolving the cum 38 to avoid an excessive negative pressure inside the cap 35, when the sucking means 48 revolves in the reverse direction (R direction).

The above-mentioned operation is executed so as to reduce fluctuations of sucked ink volume by making the pressurizing rollers 33 start rotating in the L direction from the pressurized status against the sucking tubes 32 whenever sucking recovery operations are started. Since sucking operations for eject recovery are respectively set for the black ink and color ink, a sucking mode is selected (step S107). The selection of the sucking modes are executed by opening/closing operations of communicating valves 46a and 46b which control the pressure inside the cap 35 while the cap 35 is pressed against the recording head 3 by controlling communicating valves 46a and 46b. More specifically, a negative pressure is generated inside of the cap 35 by the sucking recovery means 48 with the aid of communicating valves 46a and 46b.

As shown in FIG. 9 to FIG. 12, the pressure inside the cap 35 is controlled by opening or closing communicating valves 46a and 46b. In the present invention, communicating valves 46a and 46b can control the respective pressures of inner spaces of the cap 35, which is formed as one-pieced body.

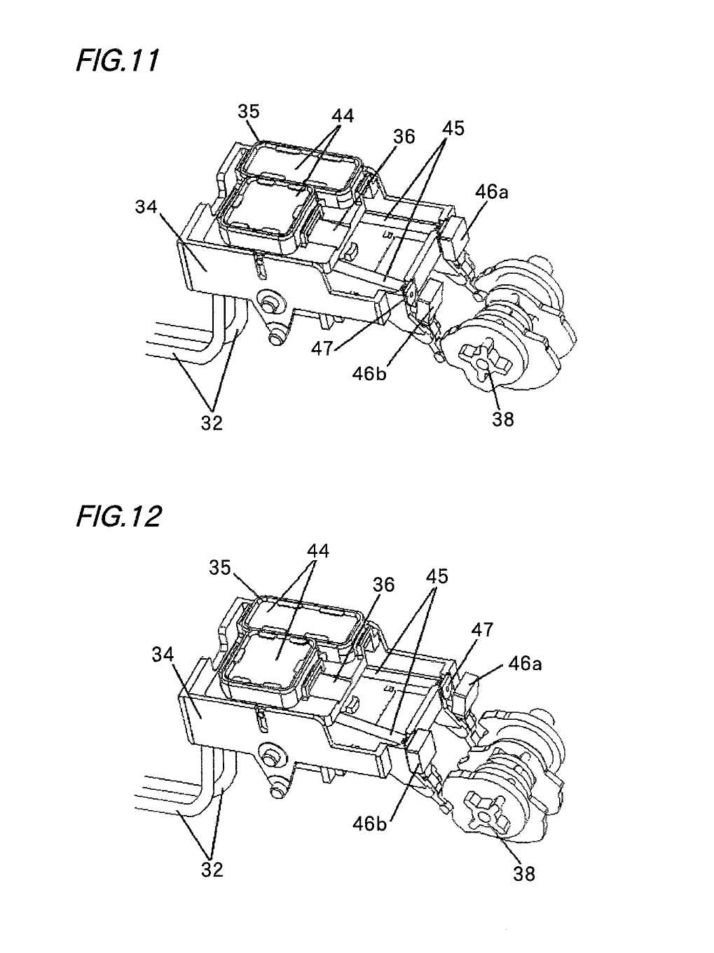

FIG. 9 is the perspective view illustrating closed status of communicating valves 46a and 46b where the cap protects the eject port surface of the recording head 3. FIG. 10 is the perspective view illustrating a status where the communicating valves 46a and 46b are open for keeping inside of the cap 35 in communicating status to the atmosphere and for ejecting ink inside the cap 35 before the sucking operation for eject recovery (the above-mentioned initial operation before sucking operation by the pressurizing rollers). FIG. 11 is the perspective view illustrating a status where the black ink is sucked (the communicating valve 46a for the black ink is closed) FIG. 12 is the perspective view illustrating a status where color inks are sucked (the communicating valve 46b for color ink is closed).

After selecting sucking modes, the driving force from the PG motor M3 is transmitted to the sucking means 48 so as to suck predetermined respective volumes of the black and color inks (revolution numbers of the sucking pump are set differently for the black ink and color inks) according to respective sucking instructions (step S108). Then as shown in FIG. 10 communicating valves 46a and 46b are opened by revolving the cum 38 for ejecting ink inside the cap 35.

After bringing communicating valves 46a and 46b into open statuses, a dummy sucking operation for ejecting sucked ink inside the cap 35 is executed by driving the sucking means 48 in the L direction via driving force from the PG motor M3 (steps S109, S110). Thus a usual sucking operation for eject recovery is finished. The sucking modes for eject recovery are executed by combining the single sucking mode of the black ink, the single sucking mode of color ink and continuous sucking mode of black and color inks.

In order to carry out the above-mentioned sucking operation for eject recovery stably, the present invention takes the following measures.

FIG. 7 is the cross sectional side view showing the cap structure in FIG. 5. FIG. 8 is the partially perspective plan view depicting the geometrical relation between the cap holder 36 and the cap 35. The space 57 for the black ink and the space 58 for the color ink in the cap 35 in this embodiment are different from each other in their shapes as shown in FIG. 5 and FIG. 7. When the predetermined capping pressure is applied to the capping means 11 after pressing against the eject port surface of the recording head 3, applying positions of compression springs 43 to the cap holder 36 are set on a line formed by the plane of the cap holder 36 and its perpendicular plane passing through the center of gravity G of a plane of the cap rib 41, at the opposite sides in relation to the line so that the predetermined pressure can be stably applied to the recording head 3 pressed against the cap rib 41.

A uniformly distributed pressure to even one-pieced asymmetrically formed cap, which tends to be unstable by the applied pressure, is attained by applying the pressure to the center of gravity G of the cap rib plane 41. In order to form stable closed space between the cap 35 and the eject port surface of the recording head, the plane of the cap rib 41 pressed against the eject port surface are preferably arranged on the same plane (in other words heights Z shown in FIG. 7 from the bottom to cap rib planes should be the same). Since points X, cap rib crossing points, are harder to deform than other cap rib portions, a width T1 of the center portion of the cap rib (width of the outer-periphery of the cap rib) dividing the black ink space 57 and color ink space 58 is set equal to or less than a width (a width of a cap partition rib) T2 of the other surrounding cap rib portions, namely, T1≦T2.

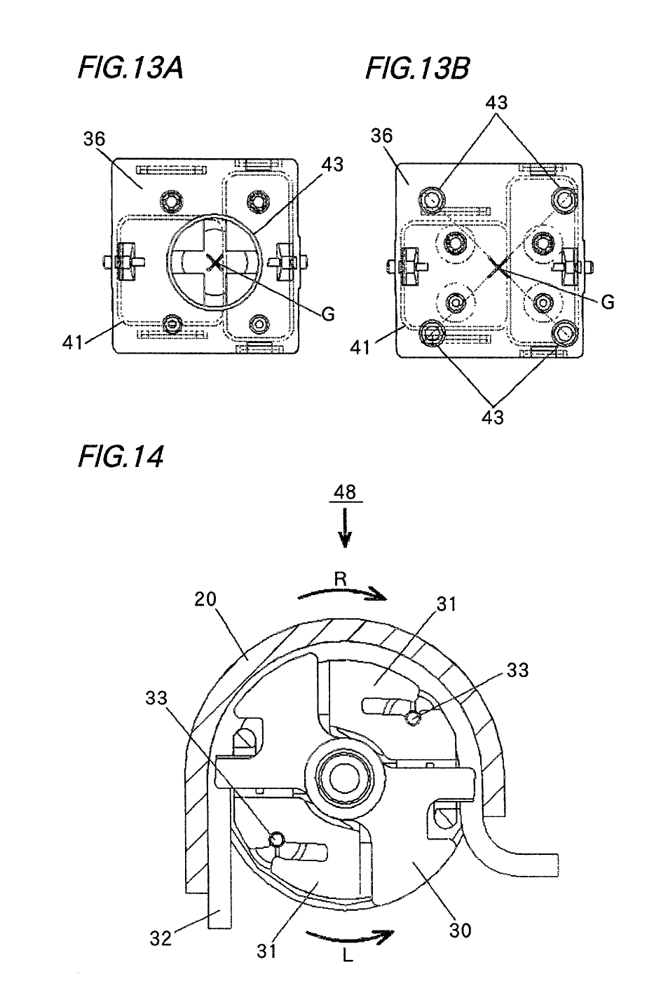

FIG. 13A and FIG. 13B are plan views illustrating arrangements how pressures from compression springs 43 are applied to the cap holder 36.

As shown in FIG. 13A, one big compression spring 43 capable of applying a pressure over a wide area is arranged at the center of gravity G of the rib plane or below the rib plane along a perpendicular line to the rib plane passing through the center of gravity G of the rib plane, to the rib plane so as to attain the same effect as the above-mentioned embodiment (see FIG. 8).

The same effect is attained when several compression springs 43 are arranged as shown in FIG. 13B. Several pairs of compression springs 43 are arranged in the same way as in the case of FIG. 8, when springs are positioned on or below the plane of the cap holder 36 so as to surround a perpendicular line to the plane of cap rib 41 passing through the center of gravity G of a plane of cap rib 41.

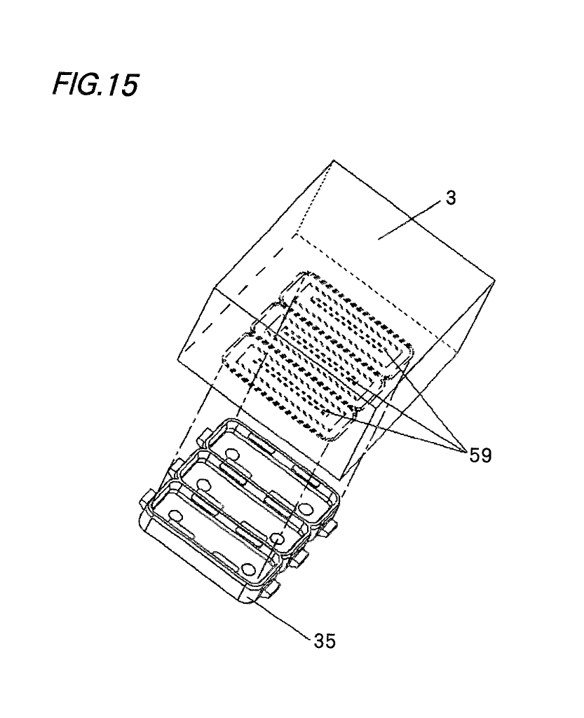

FIG. 15 is the perspective view of the other embodiment illustrating the vicinity of eject port surface of the recording head 3 pressed against the cap 35 having a plurality of spaces. Even a recording head with high density having nozzle rows 59 for different colors as shown in FIG. 15 may attain the same effect as previously described embodiments, when three respective spaces with one cap have sucking means and communicating valves respectively.

The present invention may provide an ink-jet recording apparatus equipped with the stable and widely applicable to ink eject recovery means capable of capping over the compact recording head having a plurality of nozzles and nozzle rows regardless of ink properties and recording head types.

In the above-mentioned embodiments, the serial type ink-jet recording apparatus where the recording means moves relatively against the recording medium is explained as the example where the eject recovery means is employed. But the present invention is also applicable to a full or a partial line type recording means for a line type ink-jet recording apparatus that attains the same effect.

The present invention may be applicable to a recording apparatus having one recording means, a color recording apparatus having a plurality of recording means for different colors or a gradient recording apparatus having a plurality of recording means for different contrasts of the same color and may be also applicable to any combination of preceding recording apparatuses, which can attain the same effects as the embodiments described above.

Further the present invention may be applicable to any arrangement of the recording head and the ink tank such as the arrangement having an exchangeable cartridge where the recording head and the ink tank are formed in one piece, or the arrangement having ink supply tubes etc. connecting the individually formed recording head and the ink tank, which can keeping the same effects as the embodiments mentioned above.

The present invention may be applicable to a recording head having electromechanical energy conversion elements such as piezo-electric elements etc. However, the present invention may be most effectively applied to the ink-jet recording apparatus having the recording means where ink is ejected by utilizing thermal energy among various recording head types, since recordings with high density and with fine pattern can be relatively easily attained in the thermal energy type recording head.

As mentioned above, the present invention comprises the following fundamental arrangements. In the ink-jet recording apparatus equipped with the recording head having a plurality of nozzles and nozzle rows ejecting ink from eject ports thereon and the carriage on which the recording head is mounted, the cap for capping a plurality of nozzles for ejecting ink from eject port thereon, communicating valves for communicating the inner spaces of the cap to the atmosphere, opening/closing means for the communicating valves, the sucking means communicated to the cap sucking ink from the eject ports for ink eject recovery are arranged. The cap is formed in one piece having a plurality of the inner spaces corresponding to a plurality of the nozzle rows. The cap is equipped with the capping means for connecting/disconnecting the cap to eject port surfaces of the recording means. The cap has a plurality of inner spaces to which valves are communicated, communicating valve opening/closing means for closing or communicating the inner spaces of the cap against the atmosphere and the sucking means for sucking ink from the recording head for ink eject recovery.

The above-mentioned cap has respective partitions formed as one wall dividing the cap into a plurality spaces where the thickness of the partitions is set equal to or less than that of other surrounding ribs and planes pressing against the eject port surface of respective spaces are arranged on the same plane. The capping means comprises the cap holder for fixing the cap, compression springs pressed against the bottom surface of the capping means, the cap base for supporting the compression springs from the opposite direction and for supporting the cap holder so as to generate the capping pressure in the capping holder against eject port surface of the recording head and the cap lever for connecting or disconnecting the cap base to the recording head.

The above-mentioned arrangement provides the ink-jet apparatus equipped with the stable and widely applicable to eject recovery means regardless of ink properties and recording head types, where capping operations against the compact and highly densified recording head having a plurality of nozzles and nozzle rows are realized.

In the above explained arrangement, one compression spring of the capping means, as pressing means, is arranged on the center of gravity of the rib plane contacting with eject port surfaces or below the rib surface along the perpendicular line to the rib plane passing through the center of gravity of the rib plane. Or a plurality compression springs are arranged on or below the plane of the cap rib so as to surround the line perpendicular to a plane of cap rib passing through the center of gravity G of the plane of cap rib. As a result even in the asymmetrically shaped cap capping pressure on the eject port surface of the recording head may be applied with good balance, which enable to provide the ink-jet recording head having more stable eject recovery means.

Since the sucking means employs the tube pump where the negative pressure is generated at the eject ports by pressing the sucking tubes connecting to eject ports of the recording means via the capping means, ink sucking volumes may be set variably according to desired volumes regardless of ink properties and recording head types by adjusting operating duration of the pump, consequently, more widely applicable eject recovery device can be provided.

As mentioned above the present invention attains the following effect. The ink-jet recording head having the stable and widely applicable eject recovery means capable of capping against a plurality of nozzles and nozzle rows and adjustable to respective eject recovery conditions may be provided regardless of ink properties and recording head types.

What is claimed is:

1. An ink-jet recording apparatus comprising:
a cap for capping a plurality of eject ports for ejecting ink,
a communicating valve for communicating said cap to an atmosphere,
a sucking means communicated to said cap for sucking ink from said eject ports, wherein;
said cap has a plurality of inner spaces in an integrated form respectively corresponding to said eject ports, and
a plurality of said communicating valves are provided so as to communicate to said inner spaces respectively.

2. The ink-jet recording apparatus according to claim 1 comprising:
a recording head having a plurality of eject port rows for ejecting ink,
a carriage for mounting said recording head to move reciprocatingly,
a capping means for making said cap in contact to or separated from an eject port surface of said recording head,
a switching means for opening or shutting said communicating valves, wherein;
said cap is formed in one piece having a plurality of said inner spaces respectively corresponding to said eject port rows of said recording head.

3. The ink-jet recording apparatus according to claim 2 wherein;
a partition dividing said cap into a plurality of said inner spaces is formed in one wall and a thickness of said partition is set equal to or less than a thickness of other surrounding rib of said cap, and
contact surfaces of said cap surrounding said inner spaces to be in contact with said recording head are arranged on a same plane.

4. The ink-jet recording apparatus according to claim 2, wherein said capping means comprises:
a cap holder to fix said cap,
one or more compression springs for applying pressure to a bottom plane of said cap holder,
a cap base for supporting the opposite ends of said compression springs and for supporting said cap holder so that said cap holder generates a capping pressure against the eject surface of said recording head, and
a cap lever for bringing said cap base closely to said recording head or for keeping said cap base away from said recording head.

5. The ink-jet recording apparatus according to claim 4 wherein:
said one compression spring of said capping means is arranged at the center of gravity of a rib plane formed by a contacting plane contacting with the eject port surface of said recording head or below the rib plane along a perpendicular line to the rib plane passing through the center of gravity of the rib plane;
or said compression springs of said capping means are arranged on or below the bottom plane of the cap holder so as to surround the perpendicular line to rib plane passing through the center of gravity of the rib plane.

6. The ink-jet recording apparatus according to claim 1, wherein;
said sucking means is formed as tube pumps for generating a negative pressure around said eject ports by pressing pressurizing rollers against tubes connected to eject ports of said recording head so as to eject ink from said eject ports, and
said pressurizing rollers are moved in a direction for relieving the applied pressure against tubes when said pressurizing rollers are driven in a reverse direction of applying the pressure.

7. The ink-jet recording apparatus according to claim 2, wherein;
said recording head is equipped with electro-thermal energy conversion elements to generate thermal energy utilizing for ejecting ink.

8. The ink-jet recording apparatus according to claim 7, wherein;
ink is ejected from eject ports by utilizing film boiling in the ink caused by thermal energy generated from said electro-thermal elements.

9. A cap for use in an ink-jet recording apparatus for capping a plurality of eject ports for ejecting ink, wherein:
said cap has a plurality of inner spaces in an integrated form respectively corresponding to said eject ports.

10. The cap according to claim 9, wherein:
a partition dividing said cap into a plurality of said inner spaces is formed in one wall and a thickness of said partition is set equal to or less than a thickness of other surrounding rib of said cap, and
contact surfaces of said cap surrounding inner spaces to be in contact with said recording head are arranged on a same plane.
